(19) United States
(12) Patent Application Publication
(10) Pub. No.: US 2022/0112836 A1
(43) Pub. Date: Apr. 14, 2022

(54) ENERGY CAPTURE DEVICE

(71) Applicant: Alternative Sustainability IP LLC, Fleming Island, FL (US)

(72) Inventor: John A. STEVENS, New York, NY (US)

(73) Assignee: Alternative Sustainability IP LLC, Fleming Island, FL (US)

(21) Appl. No.: 17/495,536

(22) Filed: Oct. 6, 2021

Related U.S. Application Data
(60) Provisional application No. 63/198,286, filed on Oct. 8, 2020.

(51) Int. Cl. F02B 37/22; F02C 6/18; F03D 1/04

(52) U.S. Cl. CPC F02B 37/22; F03D 1/04; F02C 6/18

(57) ABSTRACT

An energy capture device is disclosed. The energy capture device, notably, comprises a turbine and a static velocity increasing device, surrounded by an enclosure. The turbine is configured to receive air that has been sped up by the static velocity increasing device. The turbine is then able to convert the energy of fluid movement into electricity.

### CLAIM OF PRIORITY

This application claims priority to U.S. Provisional Patent Application No. 63/198,286, filed Oct. 8, 2020, entitled “Energy Recapturing Device”, the contents of which are hereby incorporated by reference in their entirety.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### FIELD OF THE EMBODIMENTS

The present disclosure relates generally to a device for capturing energy. More particularly, the present disclosure relates to an energy capture device that uses a static velocity increasing device in conjunction with a turbine to generate power.

### BACKGROUND

The United Nations and the International Organization for Migration both estimate that roughly three million people move to cities each week. In 1930 about 30% of the global population lived in cities. Today, that number is almost 55%. Thus, there has been a need like never before to safely construct large buildings for housing and places of commerce. Consequently, heating, ventilation, and air conditioning (“HVAC”) systems have become mainstays in large buildings in cities across the world. Although HVAC systems are necessary to properly clean, filter, and climate-control the air, there is a great deal of wasted energy associated with their use.

In order to offset the wasted energy of modern HVAC systems many buildings have turned to using renewable sources of energy, such as solar, hydroelectric, and wind power. Although the earliest windmills date back to the 9^{th} century where they were used by Persians to grind grain and draw water. Today, the fundamentals behind the basic windmill have been extrapolated to convert the energy of the wind into electricity. Wind power has been praised as being one of the most efficient and sustainable forms of renewable energy. Consequently, the Global Wind Energy Council and Greenpeace International boast that by 2050 25 to 30% of global energy will be harvested via wind power.

Further, this increased interest in renewable energy is directly correlated to the recent attentiveness to sustainability. As the threat of energy crisis and climate change becomes more evident, large segments of the global population have come to terms with the inarguable need to move from fossil fuels to renewable sources of energy. Accordingly, city, state, and federal, governments have taken initiative and passed a myriad of rules and regulations aimed at mitigating the burden on the environment. Specifically, many cities, including New York, have passed building regulations that dictate the manner in which a building may be constructed and/or set energy efficiency requirements. Consequently, there is a need for innovation enabling renewable energy use in urban cities. However, there are a number of distinct hurdles that are encountered when attempting to utilize wind power in urban centers.

A typical onshore wind turbine can range from 300 to 600 feet tall, with blades exceeding 100 feet in length. For most urban, and even suburban cities, a typical onshore wind turbine is physically too large to coexist with the city's buildings and inhabitants. Additionally, in the event that a typical onshore wind turbine could meet the spatial requirements for installation, there are a number of concerns including: unsightly appearance, noise pollution, and potential damages to property or life. Many residents are deterred by the physical appearance and noise created by towering wind turbines. Although such wind turbines may be beneficial to the energy needs of these cities, the “eyesore” nature of these turbines often causes property values to decline.

A common proposal is to move wind turbines offshore. However, there are a number of disadvantages with offshore wind power. First, offshore wind farms are very expensive to build and maintain. Second, there is empirical evidence to support that offshore wind farms kill, maim, and/or otherwise disrupt, many species of migratory birds and marine life. Third, offshore wind turbines are at an increased risk of damage due to storms, hurricanes, and high seas.

Furthermore, such massive wind turbines and wind farms are inadequate in solving one of the primary issues facing urban cities, which is that singular buildings must meet energy guidelines. Therefore, for wind turbines to be more reasonably used in urban cities, wind turbines must be scaled down in size and modified to be compatible with large urban buildings. Additionally, traditional tower-style wind turbines are ineffective in major cities where there are buildings at different heights that disrupt steady wind streams.

The invention of the present disclosure solves this problem by allowing an energy capture device to be placed as a free-standing device which may use a separate means, such as a fan, to draw air through one or more power-generating turbines. The invention of the present disclosure prescribes that the one or more turbines may be configured with a static velocity increasing device. Such an invention allows the turbine to harness energy from a constant high-velocity airflow, which is not always the case with external wind turbines. Further, the invention of the present disclosure may be housed within buildings, or on rooftops, thereby being invisible to the inhabitants of a given city.

### SUMMARY

The present disclosure provides for an energy capture device, including a turbine having a receiving end, an exhaust, and a rotational means for producing energy disposed therebetween, preferably where the rotational means for producing energy produces energy by air passing through the turbine, a static velocity increasing device having a first end proximate to and in fluid communication with the turbine, and a second end, the first end having a first size and the second end having a second size, the second size being larger than the first size, and a fan in fluid communication with the turbine, preferably where the fan is configured to accelerate a velocity of air in fluid communication therewith by pushing the air through the fan and towards the turbine.

In some embodiments, the fan is in fluid communication with air exhausted from the exhaust of the turbine.

In some embodiments, the energy capture device further includes an inverter and a turbine controller, each of which are configured such that the inverter and the turbine controller are in electronic communication with the turbine.

In some embodiments, the energy capture device further includes a battery, configured such that the battery is in electronic communication with the inverter and the turbine. In a preferable embodiment, the battery is further configured such that it is in electronic communication with the fan.

In some embodiments, the energy capture device further includes a solar panel, configured such that the solar panel is in electronic communication with the inverter and the battery.

In some embodiments, the energy capture device further includes a rack. In an exemplary embodiment, the energy capture device further includes a rack, upon which the turbine, the static velocity increasing device, the fan, the inverter, the turbine controller, the solar panel, and the battery are mounted.

In some embodiments, the energy capture device is located proximately to and in fluid communication with an air exhaust of a building.

The present disclosure also provides for an energy capturing system, including a plurality of energy capture devices. In preferable embodiments, each device includes a turbine having a receiving end, an exhaust, and a rotational means for producing energy disposed therebetween, preferably where the rotational means for producing energy produces energy by air passing through the turbine, a static velocity increasing device having a first end proximate to and in fluid communication with the turbine, and a second end, the first end having a first size and the second end having a second size, the second size being larger than the first size, and a fan in fluid communication with the turbine, preferably where the fan is configured to accelerate a velocity of air in fluid communication therewith by pushing the air through the fan and towards the turbine. In an exemplary embodiment, the energy capturing system is mounted upon a rack.

In some embodiments, the energy capturing system includes an enclosure disposed such that it surrounds the rack, preferably where at least one wall of the enclosure is a mesh screen.

In some embodiments, the energy capturing system is located proximately to, and in fluid communication with an exhaust to a building.

In some exemplary embodiments, the turbine is a plurality of turbines connected in series.

The present disclosure also provides for an energy capture device, including a plurality of turbines, each having a receiving end, an exhaust, and a rotational means for producing energy disposed therebetween, preferably where the rotational means for producing energy produces energy by air passing through the turbine, and preferably where the plurality of turbines is connected in series, a static velocity increasing device having a first end proximate to and in fluid communication with the plurality of turbines, and a second end, the first end having a first size and the second end having a second size, the second size being larger than the first size, and a fan in fluid communication with the plurality of turbines, preferably where the fan is configured to accelerate a velocity of air in fluid communication therewith by pushing the air through the fan.

In an embodiment, the fan is in fluid communication with air exhausted from the exhaust of the turbine.

In an embodiment, the energy capture device further includes an inverter and a turbine controller, each of which are configured such that the inverter and the turbine controller are in electronic communication with the turbine.

In an embodiment, the energy capture device further includes a battery, configured such that the battery is in electronic communication with the inverter and the turbine. In a preferable embodiment, the battery is further configured such that it is in electronic communication with the fan.

In some embodiments, the energy capture device further includes a solar panel, configured such that the solar panel is in electronic communication with the inverter and the battery.

In an exemplary embodiment, the energy capture device further includes a rack, upon which the turbine, the static velocity increasing device, the fan, the inverter, the turbine controller, the solar panel, and the battery are mounted.

### BRIEF DESCRIPTION OF THE PREFERRED EMBODIMENTS

In the drawings, like elements are depicted by like reference numerals. The drawings are briefly described as follows.

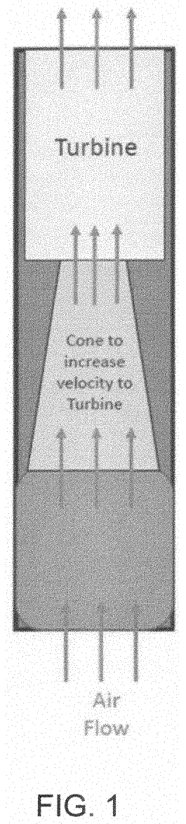

FIG. 1 is a schematic view, showing an example embodiment of the energy capture device according to the present disclosure.

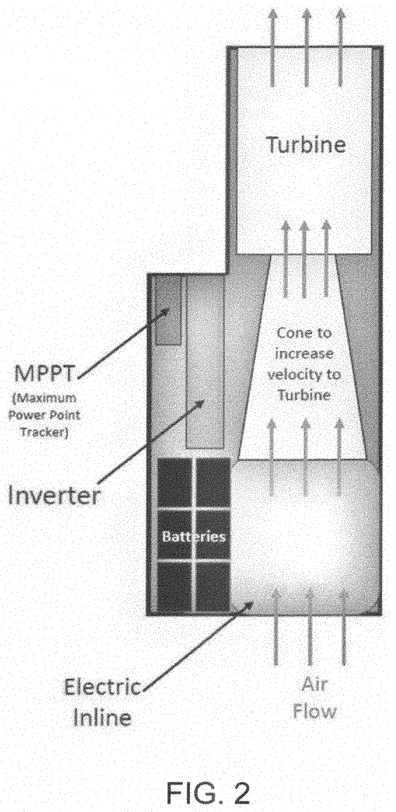

FIG. 2 is a schematic view, showing a second embodiment of the energy capture device according to the present disclosure.

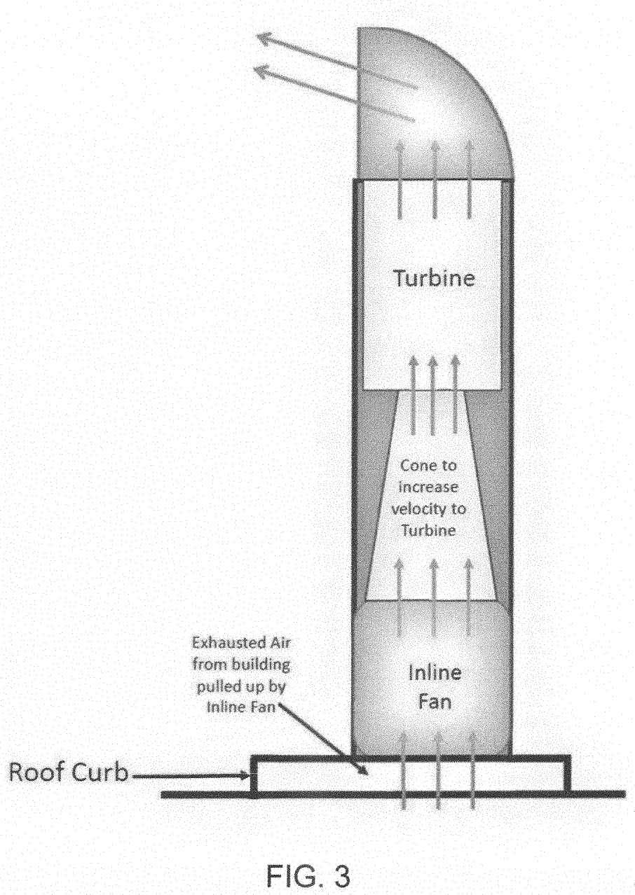

FIG. 3 is a schematic view, showing a third embodiment of the energy capture device according to the present disclosure.

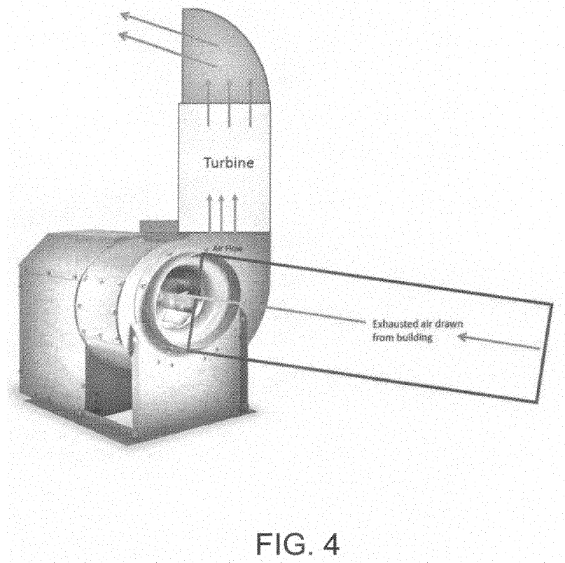

FIG. 4 is a schematic view, showing a fourth embodiment of the energy capture device according to the present disclosure.

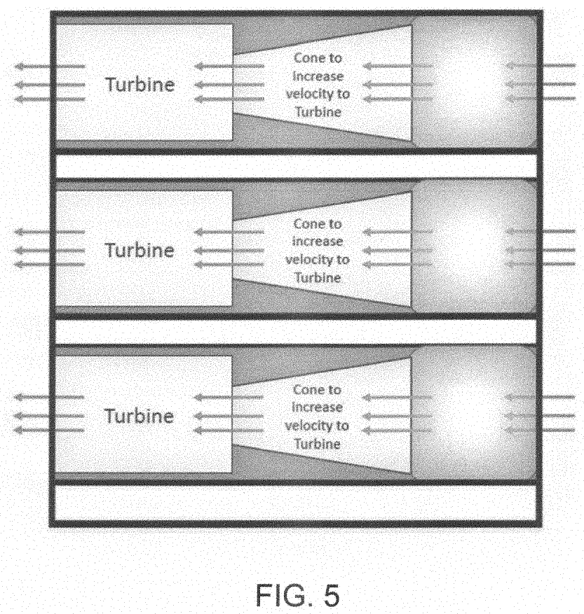

FIG. 5 is a schematic view, showing an example embodiment of a plurality of energy capture devices according to the present disclosure.

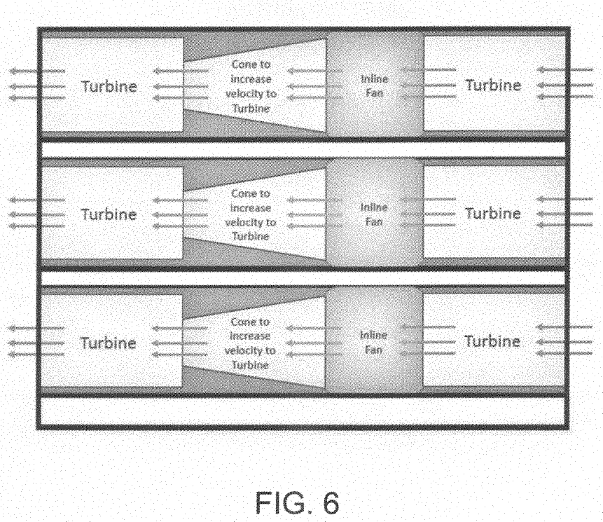

FIG. 6 is a schematic view, showing a second embodiment of a plurality of energy capture devices according to the present disclosure.

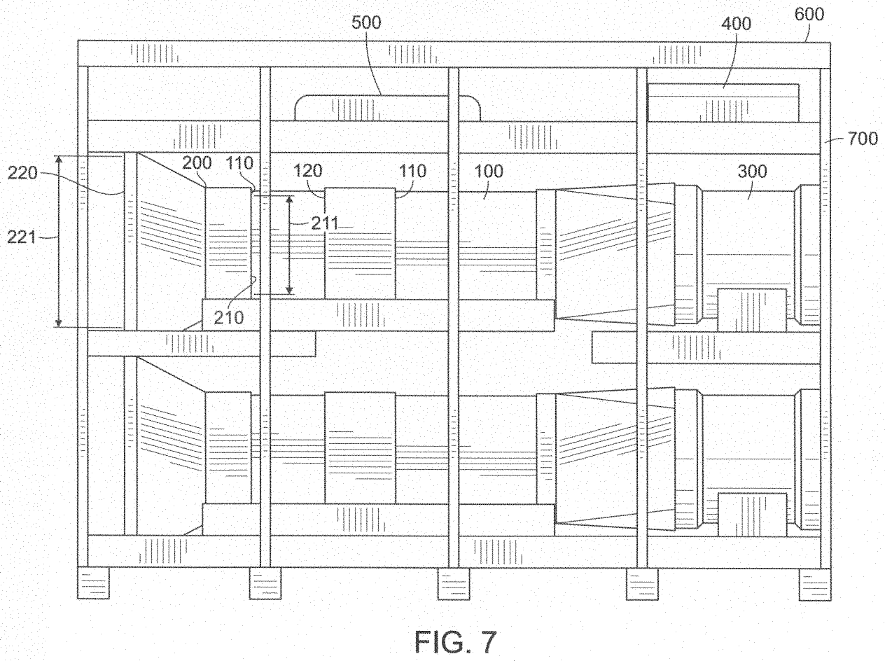

FIG. 7 is a side view of a third embodiment of a plurality of energy capture devices according to the present disclosure,

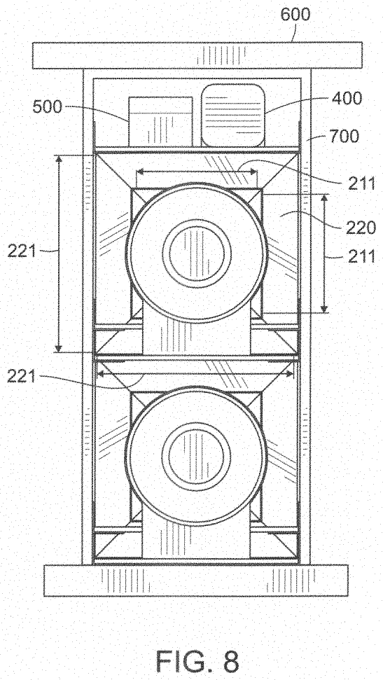

FIG. 8 is a front view of a third embodiment of a plurality of energy capture devices according to the present disclosure.

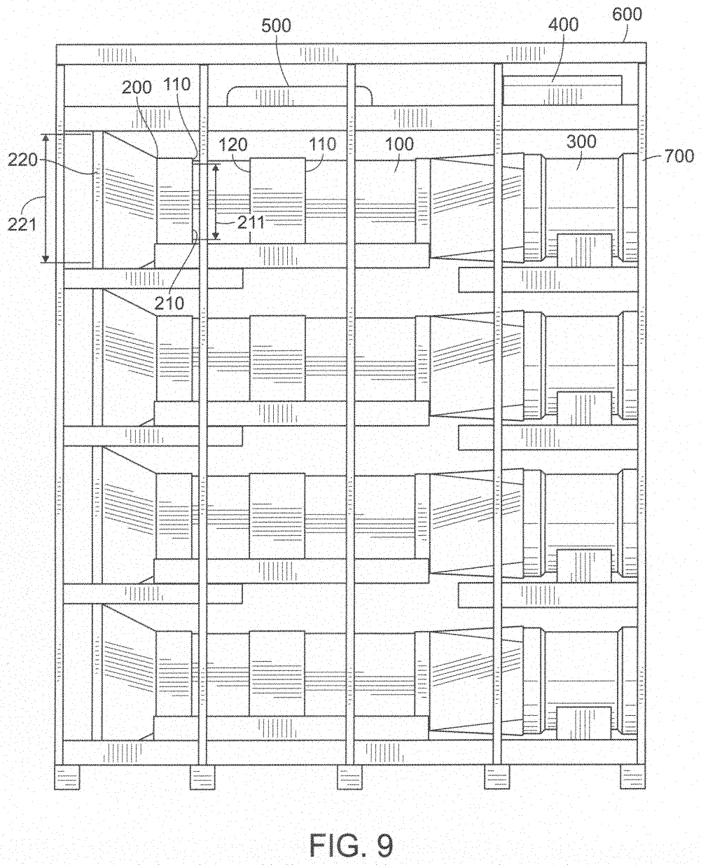

FIG. 9 is a side view of a fourth embodiment of a plurality of energy capture devices according to the present disclosure.

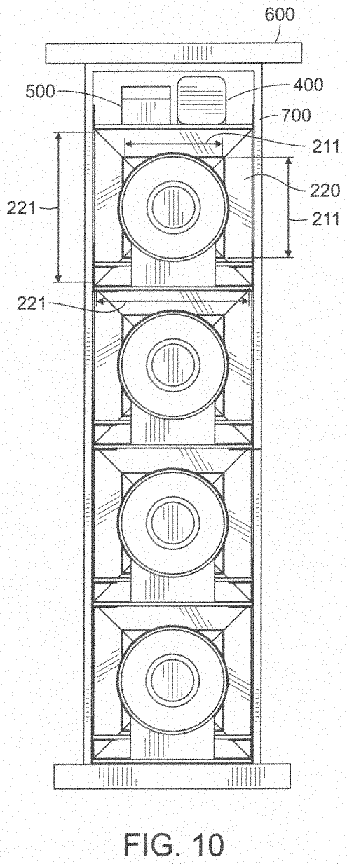

FIG. 10 is a front view of a fourth embodiment of a plurality of energy capture devices according to the present disclosure.

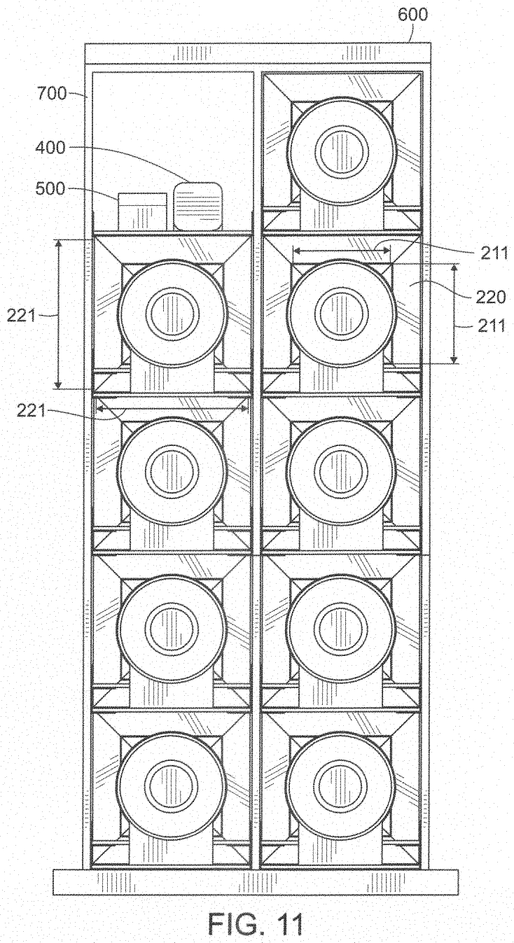

FIG. 11 is a front view of a fifth embodiment of a plurality of energy capture devices according to the present disclosure.

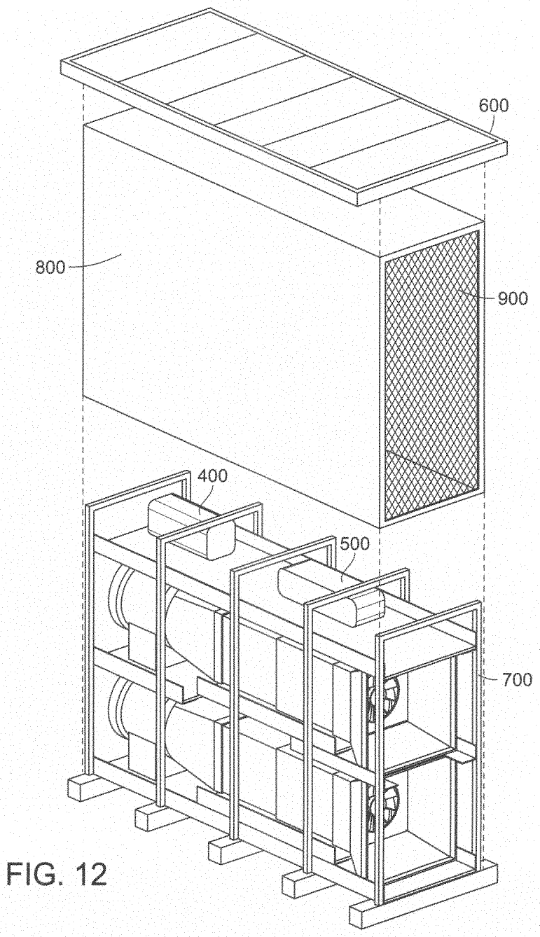

FIG. 12 is an exploded perspective view of a sixth embodiment of a plurality of energy capture devices according to the present disclosure.

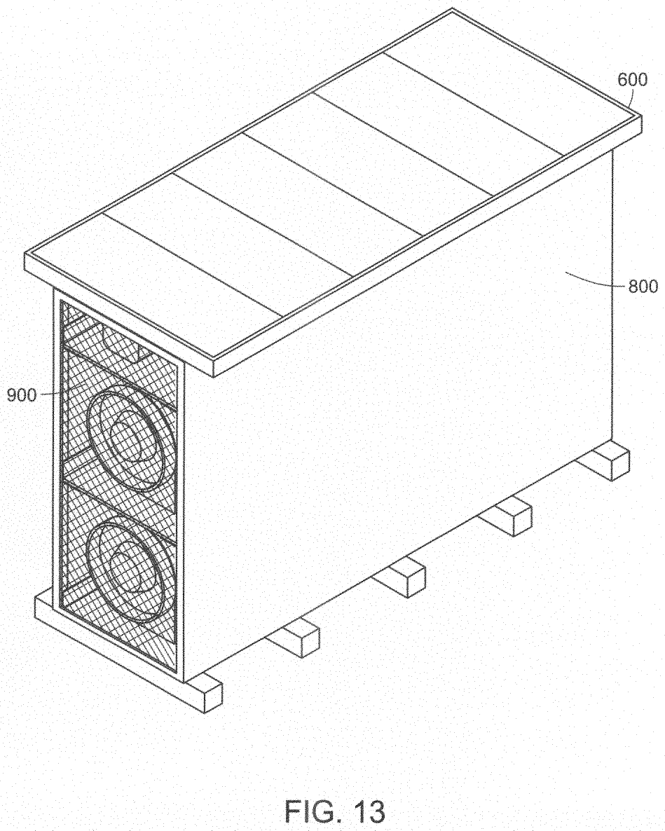

FIG. 13 is an alternate perspective view of a sixth embodiment of a plurality of energy capture devices according to the present disclosure.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete, and fully conveys the scope of the present disclosure to those skilled in the art. In fact, it will be apparent to those skilled in the art that various modifications and variations can be made in the present invention without departing from the scope or spirit of the invention.

### DETAILED DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

In the present disclosure, where a document, act, or item of knowledge is referred to or discussed, this reference or discussion is not an admission that the document, act, item of knowledge, or any combination thereof that was known at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed. It is contemplated that the claims may encompass one or more of the conventional technical aspects discussed herein.

Referring to FIG. 1, an embodiment of the energy capture device is shown. Here, the energy capture device has an input for exhausted air, a static velocity increasing device, and a turbine. Preferably, the static velocity increasing device has a first end with a first size and a second end with a second size. Also, preferably, the turbine has a receiving end, an exhaust, and a rotational means for producing electricity.

In some embodiments, the energy capture device comprises an enclosure. In a preferable embodiment an enclosure surrounds the input for exhausted air, the static velocity increasing device, and the turbine. In one embodiment, the enclosure has four walls, a left wall, a right wall, a top wall, and a bottom wall. Each of these four walls have an internal side and external side. Preferably, the velocity increasing device is disposed on each of the left wall, the right wall, the top wall, and the bottom wall of the enclosure. However, there are other embodiments where the static velocity increasing device is disposed only on to two sides, which are preferably opposite sides. For example, in this embodiment the static velocity increasing device may be disposed on the left wall and the right wall or the top wall and the bottom wall. However, there are alternative embodiments where the static velocity increasing device is disposed on only one of the four walls of the enclosure.

There are further alternate embodiments where the static velocity increasing device is disposed on three of the four walls of the enclosure. The aforementioned embodiments do not act as a means of limiting the number of sides an enclosure or other fluid passageway may have. For example, in an embodiment where the enclosure has six sides, the static velocity increasing device may be disposed on any number of the six sides.

Preferably, the static velocity increasing device has a number of external sides that interface with the inside walls of the enclosure or preexisting fluid passageway. In this same embodiment the static velocity increasing device has a number of internal sides that interface with the air as it passes through the enclosure or preexisting fluid passageway. It is preferable that the internal sides of the static velocity increasing device are smooth. However, in alternate embodiments the internal sides of the static velocity increasing device are textured.

In alternative embodiments the first size and the second size are adjustable. This may be accomplished by configuring the static velocity increasing device such that the walls of the device may be easily shifted towards and away from the airflow. Shifting the walls of the velocity increasing device would change the angle at which the first end tapers to the second end. In this alternate embodiment, the adjustments are made with a winch, motor, pneumatics, hydraulics, or other means. Since the static velocity increasing device is not always visible to a human operator, in further alternate embodiments a screen or controller will be available outside the enclosure or preexisting fluid passageway, the screen or controller allowing the human operator to adjust the angle of the static velocity device. In this further alternate embodiment, the screen or controller would also display the current angle or configuration of the static velocity increasing device.

In a preferable embodiment the first end of the velocity increasing device is proximate and in fluid communication with the receiving end of a turbine. In most instances, the first size is measured as the diameter of the cross section at the first end. In those same instances, the second size is measured as the diameter of the cross section at the second end. In an exemplary embodiment the second size is larger than the first size.

In an exemplary embodiment, the static velocity increasing device is shaped like a cone. Preferably, the internal sides of the static velocity increasing device are flat and taper from the first end to the second end linearly. However, in alternative embodiments the internal sides of the static velocity increasing devices are curved. In this alternative embodiment, the internal sides may be curved to resemble an exponential curve, logarithmic curve, or other curve.

In further embodiments, a series of grooves are disposed onto the internal sides of the static velocity increasing device. In such an embodiment, the grooves may be milled into the static velocity increasing device such that the grooves spiral from the first end to the second end. In another embodiment, any number of grooves are milled into the static velocity increasing device such that the grooves are linear and extend from the first end to the second end. Alternatively, instead of removing material from the static velocity increasing device like when milling grooves, material may be added to the static velocity increasing device. In such an embodiment material may be added to create the spiraling effect from the first end to the second end. Further, material may be added to create linear jetties extending from the first end to the second end. In either of these embodiments, the added material may either be easily removable or permanently fixed.

In some embodiments, the static velocity increasing device is constructed from independent components that have been connected at each of the components ends by a means of fastening well known in the art. Connection methods include, but are not limited to, fastened by screw, bracket, adhesive, welding, or some other means of fastening.

In alternative embodiments, the static velocity increasing device is manufactured such that the static velocity increasing device is not originally independent components. Instead, in this alternative embodiment, the static velocity increasing device may either be manufactured, pressed, bent, or otherwise configured to be sized to the enclosure, preexisting fluid passageway, or duct.

In further embodiments, there are two or more static velocity increasing devices positioned between the incoming exhaust and turbine. It may also be preferable to include one or more static velocity increasing devices after the turbine. Such configurations may create pressure differentials within the system or other phenomena that positively affect the turbine's ability to generate power. In an alternate embodiment the angle of the walls of the static velocity increasing devices may be reversed so that the fluid flowing through the static velocity increasing device is slowed.

In preferred embodiments, the enclosure is shaped as a rectangle or square. However, there are further embodiments where the enclosure is shaped like as a circle, triangle, or other geometric shape. In the aforementioned embodiments, the dimensions of the enclosure may change as necessary to retrofit the enclosure into the preexisting fluid passageway if needed.

In further preferred embodiments, the enclosure has at least one mounting bracket that attaches the enclosure to a preexisting fluid passageway. Alternatively, the energy capture device may not require a separate enclosure. In such an embodiment, the energy capture device, including the turbine and the static velocity increasing device, would be attached directly to a preexisting fluid passageway.

Preferably, the turbine is attached to a mounting bracket. The turbine may be attached to the mounting bracket with screw, nuts and bolts, weld, adhesive, or other means of fastening. Preferably, the turbine is disposed at the center of the enclosure or preexisting fluid passageway. Also, preferably, the turbine comprises a plurality of blades and a rotor. The plurality of blades may be comprised of a number of blades that, preferably, each extend radially from the rotor, such that the plurality of blades are perpendicular or roughly perpendicular to the fluid flowing through the enclosure or preexisting fluid passageway. However, there are alternate embodiments where each of the plurality of blades extend radially and outward from the rotor.

Preferably each of the plurality of blades are spaced equally from each other. Also, preferably, each of the plurality of blades contains 11 blades. However, in alternate embodiments the plurality of blades may be any number of blades. In alternative embodiments, either the rotor, the turbine, the plurality of blades, the mounting bracket, or the enclosure itself, may be angled such that the plurality of blades are facing the incoming fluid at a non-perpendicular angle. In this embodiment, the plurality of blades would not be exactly perpendicular to the incoming fluid. Further, in this embodiment, the angle of the plurality of blades in relation to the incoming fluid may be adjustable.

Further, a mesh screen or other filter may be disposed such that the mesh screen or other filters completely or partially covers the receiving end of the turbine or the opening of the front end of the static velocity increasing device. Such a mesh screen or other filter may act to obstruct particles or debris that would otherwise damage the turbine. In some embodiments, at least one wall of the enclosure is a mesh screen or other filter.

Alternatively, the energy capture device may contain more than one plurality of blades. In such an embodiment, the more than one plurality of blades may be disposed such that one plurality of blades is behind the other. Preferably, in such an embodiment, each plurality of blades would be oriented at the same angle. However, there are further alternate embodiments that may benefit from more than one plurality blades such that each plurality of blades is situated at different angles.

In exemplary embodiments, the turbine's rotational means for producing electricity is derived from a generator housed within the turbine or within the enclosure. In this exemplary embodiment, the generator would be initiated by a rotating shaft connected to the plurality of blades. This would cause the generator to produce electricity. However, in other embodiments, any rotational means for producing electricity, as known in the field of wind power, may be used.

Referring to FIG. 2, this embodiment of the energy capture device comprises a turbine, a static velocity increasing device, a battery, an inverter, a Maximum Power Point Tracker (“MPPT”), and a fan. In this embodiment, preferably, power produced by the turbine is electrically transmitted to the MPPT, where the MPPT maximizes and controls current. The MPPT acts as a safeguard so that the battery is not overcharged. Next, in this embodiment, current travels from the MPPT to one or more batteries. In some embodiments there are multiple batteries, in some instances the batteries are configured as a battery bay. Further, in some embodiments the batteries are 12-volt batteries, however, in other embodiments the batteries may be different voltages. In the preferable embodiment of FIG. 2, current travels from the one or more batteries to the inverter. The inverter converts the direct current (“DC”) power from the battery into alternating current (“AC”) power. Further, in this embodiment, the fan is connected to the inverter. Thus, in this embodiment, the turbine produces power which may in turn power the fan and other equipment.

In further embodiments, the power generated by the turbine may be stored in the one or more batteries. In alternate embodiments the power generated by the turbine is sent directly to a building's preexisting electrical grid or infrastructure.

In preferred embodiments, the turbine is either attached to or contains a generator with an electrical output cable that is configured to carry electricity. Preferably the electrical output cable is connected to the MPPT or the one or more batteries. However, the electrical output cable may be connected directly to an appliance, other device that is powered by electricity, or directly or indirectly to the electrical grid of the building.

In an alternate embodiment, the turbine further comprises a nacelle which may also surround the plurality of blades, the rotor, or the generator. Preferably, this embodiment of the energy capture device also comprises one or more of the many embodiments of the static velocity increasing device as disclosed in reference to FIG. 1.

In a preferred embodiment, the turbine further comprises a brake that stops the rotation of the plurality of blades. Such a brake may be invoked when the incoming fluid or air reaches more than 150 miles per hour. However, in other embodiments, the brake may be set to different speed thresholds. In this embodiment, the turbine further comprises a controller that may start the at least one turbine at certain air speeds or initiate the brake at certain speed thresholds.

In other embodiments the turbine further comprises a gear box, a low-speed shaft, and a high-speed shaft. Preferably, the gear box is disposed between a low-speed shaft and high-speed shaft. In preferable embodiments, the gear box contains one or more gears that are configured to increase rotational speed. In this embodiment, the high-speed shaft is further attached to the generator. In an exemplary embodiment, the turbine is the MicroCube®, sold by American Wind, more thoroughly described in U.S. Pat. No. 9,331,534, the contents of which are hereby incorporated by reference in their entirety.

In alternate embodiments, the energy capture device, with reference to FIG. 2, or any of FIG. 7-13, comprises two or more turbines. These two or more turbines may be attached to at least one, but preferably more, mounting brackets. In such an alternate embodiment, the enclosure supports two or more turbines. Preferably, the two or more turbines are evenly spaced across the enclosure or preexisting fluid passageway.

In a further alternate embodiment, the energy capture device of FIG. 2 further comprises a handle as a means of making the device more easily carried. In such an embodiment, the energy capture device resembles the appearance and has the mobility of many of the common gas-powered electrical generators that are widely known to people having ordinary skill in the art. However, the functionality of the energy capture device varies greatly from commonly known gas-powered generators. In this alternative embodiment the energy capture device can be readily moved between different preexisting fluid passageways.

Referring to FIGS. 1 and 2, the energy capture device may be positioned vertically or horizontally or any angle in between.

Referring to FIG. 3, this embodiment of the energy capture device is configured to be contained by a vertical exhaust duct.

Referring to FIG. 4, this embodiment of the energy capture device is configured to be positioned on the outflow or inside of an exhaust blower.

In exemplary embodiments, the energy capture devices of FIGS. 1-4 are fitted with a seal such that when the energy capture device is disposed into the preexisting fluid passageway the seal prevents fluid from escaping. The seal is preferably made from rubber but may be composed of other materials. In another exemplary embodiment, the interior of the energy capture device is fitted with soundproofing material. Alternatively, the exterior of the energy capture devices may be fitted with soundproofing material. The soundproofing material may be composed of a foam or other material known in the arts to dampen sound.

In an embodiment, the energy capture device is mounted on a rack. In some embodiments, the rack may contain a plurality of energy capture devices mounted thereupon. Referring to FIG. 5, this embodiment is of a system of energy capture devices comprising energy capture devices which may be configured within any of the arrangements previously described in FIGS. 1-4. The embodiment as depicted by FIG. 5, is a rack system comprising two or more energy capture devices. In a preferred embodiment, each of the two or more energy capture devices comprise the components as described in any of their various embodiments in the preceding descriptions. Preferably, the embodiment as depicted by FIG. 5 comprises a rack configured to accept more than one energy capture device. The rack may be made from metal, wood, polymer, or other material.

In preferred embodiments the rack contains more than one compartments. These compartments are sized to accept an energy capture device. Preferably, once the energy capture device is inserted into the compartment, the energy capture device is then fastened in place. There exist embodiments where an energy capture device is permanently affixed to a compartment or where an energy capture device is easily removable.

In alternate embodiments, a number of energy capture devices are connected to each other without the need for a rack, creating a conglomerate of energy capture devices. In a preferred embodiment, the rack may be attached to at least one mounting bracket. In an alternate embodiment, the conglomerate of energy capture devices is attached to at least one mounting bracket. Preferably, however, the conglomerate of energy capture devices may be fastened directly to the preexisting fluid passageway.

In preferred embodiments, the rack is disposed upon a sliding mechanism such that the sliding mechanism is disposed on an exterior of the rack. Preferably, the sliding mechanism is configured to support the weight of the rack and turbine(s). Also, preferably, the sliding mechanism is comprised of one or more slide rails. In many embodiments each slide rail is rated to support up to 250 pounds of weight. In preferred embodiments, one slide rail is attached to the front end of the bottom side of the rack and a second slide rail is attached to the rear end of the bottom side of the rack. However, in alternative embodiments, the sliding mechanism is attached to any one of the sides of the rack.

Alternatively, the sliding mechanism may be connected to any one or a combination of sides of the rack. In further embodiments, the sliding mechanism has two or more slide rails.

In alternate embodiments, the rack is connected to multiple sliding mechanisms. Such an embodiment may have one sliding mechanism attached to the top side of the rack and a second sliding mechanism attached to the bottom side of the rack. However, any number of sliding mechanisms may be attached to any number or combination of sides of the rack.

In preferable embodiments the sliding mechanism enables the entire rack to be removed from a preexisting fluid passageway. However, there are other embodiments that may only allow part of the rack to be removed from the preexisting fluid passageway due to spatial or weight limitations.

Each embodiment describing the rack as being connected to a sliding mechanism may also apply to the energy capture devices as referenced in FIGS. 1-4. For example, the embodiment of the energy capture device housed within a vertical exhaust duct may also be coupled with a sliding mechanism to allow the recapturing device to be removed from the fluid passageway.

Referring to FIG. 6, each of the energy capture devices disposed within the rack may contain a second turbine before the fan. In such an embodiment fluid would flow first through a turbine, then the fan, next the static velocity increasing device, and finally another turbine.

Referring to FIGS. 5 and 6, there exists another embodiment where a substantially larger static velocity increasing device is disposed within the duct, vent, or other preexisting passageway, such that the static velocity increasing device directs fluid into the energy capture devices within the rack.

Referring to FIGS. 5 and 6, in an exemplary embodiment, the rack exterior is fitted with a seal such that when the rack is disposed into the preexisting fluid passageway the seal prevents fluid from escaping. The seal is preferably made from rubber but may be composed of other materials. In another exemplary embodiment, the interior of the rack is fitted with soundproofing material. Alternatively, the exterior of the rack may be fitted with soundproofing material. The soundproofing material may be composed of a foam or other material known in the arts to dampen sound.

Moreover, any components or materials can be formed from a same, structurally continuous piece or separately fabricated and connected.

The disclosure of the present invention also provides, with reference to any of FIG. 7-13, an energy capturing system, comprising a plurality of energy capture devices of the present disclosure mounted on a rack 700. In such embodiments, the rack 700 has a plurality of levels, with an energy capture device mounted on each level. In some embodiments, the plurality of energy capture devices is 2, 3, 4, 5, 6, 7, 8, 9, or more energy capture devices. However, in some embodiments, the rack 700 may mount only a single energy capture device.

In some embodiments, with reference to any of FIG. 7-13, each of the energy capture devices comprises one or more turbines 100, each turbine having a receiving end 110 and an exhaust 120. In embodiments composed of more than one turbine, such turbines are preferably connected in series, such that the exhaust 120 of a first turbine is proximate to and in fluid communication with the receiving end 110 of a second turbine, the exhaust 120 of a second turbine is proximate to and in fluid communication with the receiving end 110 of a third turbine, and so on. In some embodiments, where a plurality of turbines is connected in series, with reference to any of FIG. 7-13, the plurality of turbines is preferably connected through connector enclosures which surround the connection points between successive turbines.

In some embodiments, with reference to any of FIG. 7-13, each of the energy capture devices comprises a static velocity increasing device 200, having a first end 210 with a first size 211, and a second end 220 with a second size 221. In embodiments, with reference to any of FIG. 8, 10, or 11, where a plurality of energy capture devices is mounted on a rack 700 with a plurality of levels, the second end 220 and second size 221 of the static velocity increasing device is preferably sized to match a cross section of one level of the rack.

In some embodiments, with reference to any of FIG. 7-13, each of the energy capture devices comprises a fan 300. In some embodiments, the fan 300 is in fluid communication and is proximate to an exhaust of a turbine 100. In some embodiments, the fan 300 is in fluid communication with an exhaust of a turbine 100 through an adapter enclosure, which connects the exhaust of the turbine 100 to the input of the fan 300. In some embodiments, each of the energy capture devices is configured such that air enters the second end 220 of the static velocity increasing device 200, is drawn through one or more turbines 100, then is drawn through the fan 300 and exhausted through an exhaust of the fan. In some embodiments, the fan 300 may be in electronic communication with an external power supply, which powers the fan 300. In other embodiments, the fan is in electronic communication with a battery, which powers the fan 300.

In some embodiments, with reference to any of FIG. 7-13, the energy capturing system further comprises an inverter 400. Such inverter 400 preferably is in electronic communication with each turbine 100 of the plurality of energy capture devices of the energy capturing system. Such inverter preferably takes power generated by each of the turbines 100 and converts such power into alternating current (AC) from direct current (DC). In some embodiments, the inverter 400 is further in electronic communication with an electrical panel, which may then feed the current back into a power grid. In some embodiments, the inverter 400 is further in electronic communication with a battery, and the inverter preferably charges such battery during operation.

In some embodiments, with reference to any of FIG. 7-13, the energy capturing system further comprises a turbine controller 500. Such turbine controller 500 may be any turbine controller known in the art for controlling the function of power generating turbines. Preferably, the turbine controller 500 is a turbine controller used for control of wind powered turbines. In an exemplary embodiment, the turbine controller 500 is in electronic communication with each of the turbines 100, and preferably with an inverter 400, and/or a battery. In some embodiments, the turbine controller uses sensors to monitor the condition of each of the turbines 100, the inverter 400, and the battery. In such embodiments, the turbine controller 500 may, for instance, preferably prevent such turbines 100 from overheating or running at an excessive speed, or prevent such battery from overcharging, or provide other such fail-safe features.

In some embodiments, with reference to any of FIG. 12 or 13, the energy capturing system further comprises an enclosure 800 surrounding the rack 700. Such enclosure may be of any suitable shape for containing the rack 700. In an exemplary embodiment, with reference to FIG. 12 or 13, the enclosure 800 has six walls, a top wall, a bottom wall, a left wall, a right wall, a front wall, and a back wall. In a preferred embodiment, at least one wall of the enclosure 800 is a screen mesh 900. In a more preferred embodiment, the back and front walls of the enclosure 800 are screen meshes 900.

In some embodiments, with reference to any of FIG. 7-13, the energy capturing system further comprises a solar panel 600 mounted thereupon. In some embodiments, the solar panel 600 is directly mounted on top of the rack 700. In some embodiments, the solar panel 600 is mounted on top of the enclosure 900.

In some embodiments, the energy capture device generates more power than it consumes. In some embodiments, the energy capturing system generates more power than it consumes. In such embodiments, what is meant by “net power generation” is that the total power output of any turbines contained within such device or system, minus the power consumption of any fans contained within such device or system, is greater than zero. In some embodiments, the net power generation of an energy capture device of the present disclosure is between 500-2000 watts, preferably between 700-1500 watts. In some embodiments, the net power generation of an energy capturing system of the present disclosure is between 1000 and 20000 watts, preferably between 1500 and 10000 watts.

It is understood that when an element is referred hereinabove as being “on” another element, it can be directly on the other element or intervening elements may be present therebetween. In contrast, when an element is referred to as being “directly on” another element, there are no intervening elements present.

It is further understood that, although ordinal terms, such as, “first,” “second,” and “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, a “first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented an energy capture device. The disclosure is illustrated by example in the drawing figures, and throughout the written description. It should be understood that numerous variations are possible while adhering to the inventive concept. Such variations are contemplated as being a part of the present disclosure.

### Example 1

An example energy capturing system of the present invention, with reference to the embodiments disclosed in FIG. 7 and FIG. 8, was constructed. The example system included a rack with two energy capture devices contained within. Each energy capture device contained two American Wind MicroCubes®, arranged end-to-end and connected in series with a connector/metal coupling between them. Each energy capture device also contained a static velocity increasing device in the form of a 16″ turbine collar, a square-to round connector, and a 12″ inline fan, configured such that the turbine collar was attached to the front end of the two connected American Wind MicroCubes®, with the square to round connector attached to the rear end of the connected American Wind MicroCubes®, and with the inline fan connected to the other end of the square to round connector. The 12″ inline fan spins at 3,450 rpm and produces approximately 1,880 cfm of air movement.

The rack was further mounted with a turbine controller, and a power adapter/inverter device which converts the output of the turbines to AC power.

Each energy capture device in the example energy capturing system was configured such that the inline fan would draw air into the funnel collar, through the pair of turbines, and finally out through the inline fan.

The example system was installed in a building in New York City and the inline fan was plugged into a 115V outlet.

The example system was set to run for nineteen (19) days, and the voltage and energy generation data from the example system was collected. The data collected from the example system is shown in the table below:

TABLE 1

| | | | | | Gross watts | Net watts from |
|---|---|---|---|---|---|---|
| | | | DC | | from one level | one level (two |
| | | | voltage of | | (two turbines, | turbines, in series) |
| | | | two turbines | AC | in series) at 4.8 | after deducting |
| | | | connected | Voltage | amps (±.05) | 510 watts for |
| Date | Time | | in series | (DC/.636) | (Volts × Amps) | supply fan. |
| Jul. 12, 2021 | 8:30 | AM | 166 | 261 | 1,253 Watts | 743 Watts |
| Jul. 12, 2021 | 2:00 | PM | 165 | 259 | 1,243 Watts | 733 Watts |
| Jul. 13, 2021 | 8:20 | AM | 162 | 255 | 1,224 Watts | 714 Watts |
| Jul. 13, 2021 | 12:15 | PM | 163 | 256 | 1,229 Watts | 719 Watts |
| Jul. 13, 2021 | 7:05 | PM | 165 | 259 | 1,243 Watts | 733 Watts |
| Jul. 14, 2021 | 8:20 | AM | 172 | 270 | 1,296 Watts | 786 Watts |
| Jul. 14, 2021 | 11:55 | PM | 171 | 269 | 1,291 Watts | 781 Watts |
| Jul. 14, 2021 | 7:00 | PM | 168 | 264 | 1,267 Watts | 757 Watts |
| Jul. 15, 2021 | 8:15 | AM | 171 | 269 | 1,291 Watts | 781 Watts |
| Jul. 15, 2021 | 11:50 | PM | 171 | 269 | 1,291 Watts | 781 Watts |
| Jul. 15, 2021 | 7:00 | PM | 171 | 269 | 1,291 Watts | 781 Watts |
| Jul. 16, 2021 | 8:15 | AM | 169 | 266 | 1,277 Watts | 767 Watts |
| Jul. 16, 2021 | 2:50 | PM | 172 | 270 | 1,296 Watts | 786 Watts |
| Jul. 17, 2021 | 8:10 | AM | 171 | 269 | 1,291 Watts | 781 Watts |
| Jul. 17, 2021 | 2:45 | PM | 168 | 264 | 1,267 Watts | 757 Watts |
| Jul. 18, 2021 | 8:10 | AM | 168 | 264 | 1,267 Watts | 757 Watts |
| Jul. 18, 2021 | 7:15 | PM | 168 | 264 | 1,267 Watts | 757 Watts |
| Jul. 19, 2021 | 8:15 | AM | 168 | 264 | 1,267 Watts | 757 Watts |
| Jul. 19, 2021 | 11:45 | PM | 164 | 258 | 1,238 Watts | 728 Watts |
| Jul. 19, 2021 | 7:15 | PM | 164 | 258 | 1,238 Watts | 728 Watts |
| Jul. 20, 2021 | 8:15 | AM | 168 | 264 | 1,267 Watts | 757 Watts |
| Jul. 20, 2021 | 11:45 | PM | 168 | 264 | 1,267 Watts | 757 Watts |
| Jul. 20, 2021 | 7:00 | PM | 171 | 269 | 1,291 Watts | 781 Watts |
| Jul. 21, 2021 | 8:00 | AM | 165 | 259 | 1,243 Watts | 733 Watts |
| Jul. 21, 2021 | 12:00 | PM | 165 | 259 | 1,243 Watts | 733 Watts |
| Jul. 21, 2021 | 7:00 | PM | 165 | 259 | 1,243 Watts | 733 Watts |
| Jul. 22, 2021 | 8:15 | AM | 165 | 259 | 1,243 Watts | 733 Watts |
| Jul. 22, 2021 | 12:05 | PM | 165 | 259 | 1,243 Watts | 733 Watts |
| Jul. 22, 2021 | 8:00 | PM | 168 | 264 | 1,267 Watts | 757 Watts |
| Jul. 23, 2021 | 8:15 | AM | 165 | 259 | 1,243 Watts | 733 Watts |
| Jul. 23, 2021 | 11:50 | PM | 169 | 266 | 1,277 Watts | 767 Watts |
| Jul. 23, 2021 | 6:00 | PM | 169 | 266 | 1,277 Watts | 767 Watts |
| Jul. 24, 2021 | 7:15 | AM | 168 | 264 | 1,267 Watts | 757 Watts |
| Jul. 24, 2021 | 3:00 | PM | 168 | 264 | 1,267 Watts | 757 Watts |
| Jul. 25, 2021 | 7:30 | AM | 170 | 267 | 1,282 Watts | 782 Watts |
| Jul. 25, 2021 | 3:00 | PM | 171 | 269 | 1,291 Watts | 781 Watts |
| Jul. 26, 2021 | 8:15 | AM | 171 | 269 | 1,291 Watts | 781 Watts |
| Jul. 26, 2021 | 12:00 | PM | 170 | 267 | 1,282 Watts | 772 Watts |
| Jul. 26, 2021 | 7:10 | PM | 169 | 266 | 1,277 Watts | 767 Watts |
| Jul. 27, 2021 | 8:10 | AM | 170 | 267 | 1,282 Watts | 772 Watts |
| Jul. 27, 2021 | 12:00 | PM | 170 | 267 | 1,282 Watts | 772 Watts |
| Jul. 27, 2021 | 7:10 | PM | 167 | 263 | 1,262 Watts | 752 Watts |
| Jul. 28, 2021 | 8:05 | AM | 162 | 255 | 1,224 Watts | 714 Watts |
| Jul. 28, 2021 | 11:45 | PM | 162 | 255 | 1,224 Watts | 714 Watts |
| Jul. 28, 2021 | 7:15 | PM | 163 | 256 | 1,229 Watts | 719 Watts |
| Jul. 29, 2021 | 8:10 | AM | 168 | 264 | 1,267 Watts | 757 Watts |
| Jul. 29, 2021 | 1:00 | PM | 168 | 264 | 1,267 Watts | 757 Watts |
| Jul. 29, 2021 | 7:10 | PM | 170 | 267 | 1,282 Watts | 772 Watts |
| Jul. 30, 2021 | 8:05 | AM | 169 | 266 | 1,277 Watts | 767 Watts |
| Jul. 30, 2021 | 11:30 | PM | 169 | 266 | 1,277 Watts | 767 Watts |

The data collected from the example system indicated that the example system was able to capture a consistent amount of energy in excess of the input energy, between 700 and 800 watts per energy capture device, during operation. In total, the example system captured between 1500-1600 watts in excess of the input energy.

### Example 2

Four example capturing systems of the present invention, with reference to the embodiments disclosed in FIG. 7 and FIG. 8, will be constructed. Each example system will include a rack with two energy capture devices contained within. Each energy capture device will contain two American Wind MicroCubes®, arranged end-to-end and connected in series with a connector/metal coupling between them. Each energy capture device will also contain a static velocity increasing device in the form of a 16″ turbine collar, a square-to round connector, and a 12″ inline fan, configured such that the turbine collar will be attached to the front end of the two connected American Wind MicroCubes®, with the square to round connector attached to the rear end of the connected American Wind MicroCubes®, and with the inline fan connected to the other end of the square to round connector. The 12″ inline fan will spin at 3,450 rpm and will produce approximately 1,880 cfm of air movement.

The rack will further be mounted with a turbine controller, and a power adapter/inverter device which converts the output of the turbines to AC power.

Each energy capture device in the example system will be configured such that the inline fan draws air into the funnel collar, through the pair of turbines, and finally out through the inline fan.

The four example energy capturing systems will be installed as follows: two example systems in New Jersey, each in a different building; one example system in a building in Long Island, N.Y.; and one example system in a building in Florida. Each of the inline fans for each example system will be plugged into a 115V outlet to complete installation and begin operation.

The data collected from each example system will indicate that each example system is able to capture a consistent amount of energy in excess of the input energy. The net energy each example system will be able to capture, after the energy usage of the inline fan is subtracted, will be between 700 and 1000 watts per energy capture device, during operation. In total, each example system will capture between 1500-2000 watts in excess of the input energy during operation.

### Example 3

Two example energy capturing systems of the present invention, with reference to the embodiments disclosed in FIG. 9 and FIG. 10, will be constructed. Each example system will include a rack with four energy capture devices contained within. Each energy capture device will contain two American Wind MicroCubes®, arranged end-to-end and connected in series with a connector/metal coupling between them. Each energy capture device will also contain a static velocity increasing device in the form of a 16″ turbine collar, a square-to round connector, and a 12″ inline fan, configured such that the turbine collar will be attached to the front end of the two connected American Wind MicroCubes®, with the square to round connector attached to the rear end of the connected American Wind MicroCubes®, and with the inline fan connected to the other end of the square to round connector. The 12″ inline fan will spin at 3,450 rpm and will produce approximately 1,880 cfm of air movement.

The rack will further be mounted with a turbine controller, and a power adapter/inverter device which converts the output of the turbines to AC power.

Each energy capture device in the example system will be configured such that the inline fan draws air into the funnel collar, through the pair of turbines, and finally out through the inline fan.

Both example energy capturing systems will be installed in a building in New York City. Each of the inline fans for each example system will be plugged into a 115V outlet to complete installation and begin operation.

The data collected from each example system will indicate that each example system is able to capture a consistent amount of energy in excess of the input energy. The net energy each example system will be able to capture, after the energy usage of the inline fan is subtracted, will be between 700 and 1000 watts per energy capture device, during operation. In total, each example system will capture between 3000-4000 watts in excess of the input energy during operation.

What is claimed is:

1. An energy capture device, comprising:
a turbine having a receiving end, an exhaust, and a rotational means for producing energy disposed therebetween,
wherein the rotational means for producing energy produces energy by air passing through the turbine;
a static velocity increasing device having a first end proximate to and in fluid communication with the turbine, and a second end, the first end having a first size and the second end having a second size, the second size being larger than the first size; and
a fan in fluid communication with the turbine,
wherein the fan is configured to accelerate a velocity of air in fluid communication therewith by pushing the air through the fan and towards the turbine.

2. The energy capture device of claim 1, wherein the fan is in fluid communication with air exhausted from the exhaust of the turbine.

3. The energy capture device of claim 1, further comprising an inverter and a turbine controller, each of which are configured such that the inverter and the turbine controller are in electronic communication with the turbine.

4. The energy capture device of claim 3, further comprising a battery, configured such that the battery is in electronic communication with the inverter and the turbine.

5. The energy capture device of claim 4, wherein the battery is further configured such that it is in electronic communication with the fan.

6. The energy capture device of claim 5, further comprising a solar panel, configured such that the solar panel is in electronic communication with the inverter and the battery.

7. The energy capture device of claim 6, further comprising a rack, upon which the turbine, the static velocity increasing device, the fan, the inverter, the turbine controller, the solar panel, and the battery are mounted.

8. The energy capture device of claim 7, wherein the energy capture device is located proximately to and in fluid communication with an air exhaust of a building.

9. An energy capturing system, comprising a plurality of energy capture devices, each device comprising,
a turbine having a receiving end, an exhaust, and a rotational means for producing energy disposed therebetween,
wherein the rotational means for producing energy produces energy by air passing through the turbine;
a static velocity increasing device having a first end proximate to and in fluid communication with the turbine, and a second end, the first end having a first size and the second end having a second size, the second size being larger than the first size, and
a fan in fluid communication with the turbine,
wherein the fan is configured to accelerate a velocity of air in fluid communication therewith by pushing the air through the fan and towards the turbine
wherein the energy capturing system is mounted upon a rack.

10. The energy capturing system of claim 9, further comprising an enclosure disposed such that it surrounds the rack, wherein at least one wall of the enclosure is a mesh screen.

11. The energy capturing system of claim 10, wherein the energy capturing system is located proximately to, and in fluid communication with an exhaust to a building.

12. The energy capturing system of claim 9, wherein the turbine is a plurality of turbines connected in series.

13. An energy capture device, comprising:
a plurality of turbines, each having a receiving end, an exhaust, and a rotational means for producing energy disposed therebetween,
wherein the rotational means for producing energy produces energy by air passing through the turbine,
and wherein the plurality of turbines is connected in series;
a static velocity increasing device having a first end proximate to and in fluid communication with the plurality of turbines, and a second end, the first end having a first size and the second end having a second size, the second size being larger than the first size; and
a fan in fluid communication with the plurality of turbines,
wherein the fan is configured to accelerate a velocity of air in fluid communication therewith by pushing the air through the fan.

14. The energy capture device of claim 13, wherein the fan is in fluid communication with air exhausted from the exhaust of the turbine.

15. The energy capture device of claim 14, further comprising an inverter and a turbine controller, each of which are configured such that the inverter and the turbine controller are in electronic communication with the turbine.

16. The energy capture device of claim 15, further comprising a battery, configured such that the battery is in electronic communication with the inverter and the turbine.

17. The energy capture device of claim 16, wherein the battery is further configured such that it is in electronic communication with the fan.

18. The energy capture device of claim 17, further comprising a solar panel, configured such that the solar panel is in electronic communication with the inverter and the battery.

19. The energy capture device of claim 18, further comprising a rack, upon which the turbine, the static velocity increasing device, the fan, the inverter, the turbine controller, the solar panel, and the battery are mounted.
